(19) United States
(12) Patent Application Publication
(10) Pub. No.: US 2005/0091064 A1
(43) Pub. Date: Apr. 28, 2005

(54) Speech recognition module providing real time graphic display capability for a speech recognition engine

(76) Inventor: Curtis A. Weeks, Loveland, OH (US)

Correspondence Address: Donald J. Ersler, 725 Garvens Avenue, Brookfield, WI, 53005, US

(21) Appl. No.: 10/690,681

(22) Filed: Oct. 22, 2003

(51) Int. Cl. G10L 11/00

(52) U.S. Cl. 704/276

(57) ABSTRACT

A speech recognition module includes transformation and synchronization algorithms. The transformation algorithms receive raw text from the speech recognition engine and produce a mapped text file and a module mapped text file. The mapped text file contains all the characters in the raw text. The characters in the mapped text file are mapped to locations in the module mapped text file. The characters in the module mapped text file are mapped to the mapped text file. A module window is created to edit the mapped text file by first editing the module mapped text file. Any graphical display, such as a fill-in form or header are viewable during or after dictation in the module window. Changes made to the module mapped text file are automatically implemented in the mapped text file through the synchronization algorithms.

### BACKGROUND OF THE INVENTION

1. Field of the Invention

The present invention relates generally to a speech recognition engine and more specifically to a speech recognition module that provides real time graphic display capability for the speech recognition engine.

2. Discussion of the Prior Art

The prior art provides a speech recognition engine, which includes context adaptation and synchronized playback. The speech recognition engine provides raw text that the dictator can correct. The raw text may contain spoken text, commands and headers. The raw text may be corrected with or without synchronized playback. However, if there are no errors in the raw text, then it does not need to be corrected before context adaptation. The synchronized playback provides playback of the dictation and highlights words in an editing window as the words are spoken. The synchronized playback allows the dictator to more easily identify and correct text that was improperly recognized by the speech recognition engine.

Context adaptation may process a raw text file or a corrected raw text file to generate statistics information on a particular dictator's sentence structure, unknown words, word frequency, and word combinations. The adaptation process is critical to the learning process of the speech recognition engine. As more of the corrected raw text files are processed, the speech recognition accuracy will continue to improve for the dictator. In order for the context adaptation process to be successful, only text derived from what the dictator actually says should be processed. Other text that may be part of the corrected raw text file that was not actually dictated by the dictator, should not be sent through the context adaptation process, as this could significantly impair the learning process.

As a result of supporting context adaptation and synchronized playback, the speech recognition engine architecture does not lend itself well to features such as fill-in forms, tables, insertion of normal text, and displaying the resulting text in a different way. Further, the dictator is not able to see the final formatted text as they dictate.

Accordingly, there is a clearly felt need in the art for a speech recognition module, which provides real time graphic display capability for a speech recognition engine that allows tables, fill-in forms, headers and like to be displayed while a dictator is speaking.

### SUMMARY OF THE INVENTION

The present invention provides a speech recognition module that provides real time graphic display capability for a speech recognition engine. The speech recognition module includes transformation algorithms and synchronization algorithms. The transformation algorithms receive raw text from the speech recognition engine and produce a mapped text file and a module mapped text file. The mapped text file contains all the characters in the raw text. Any command text strings are replaced with alphabetic or numeric characters in the module mapped text file. All the characters in the mapped text file are assigned to a transform column of a character mapping chart. All the characters in the module mapped text file are assigned to a module column of the character mapping chart. The characters in the module column are mapped to addresses in the transform column. The characters in the transform column are mapped to addresses in the module column. Context adaptation may be performed on the mapped text file with or without correction, if there are no recognition errors.

Normally, the speech recognition engine provides an editing window for making corrections to the raw text. However, when using the speech recognition module, the editing window is preferably hidden. A module window is created by the speech recognition module to view and edit the module mapped text file. Any graphical display, such as a fill-in form, table or header are viewable during or after dictation in the module window. Corrections made to the mapped text file with or without synchronized playback are made in the module window. The corrections are first made to the module mapped text file. Corrections made in the module mapped text file are automatically implemented in the mapped text file by the synchronization algorithms. The module window displays highlighted text that would be normally seen in the editing window during synchronized playback.

Accordingly, it is an object of the present invention to provide a speech recognition module, which provides graphic display capability for a speech recognition engine that allows tables, fill-in forms, headers and like to be displayed while a dictator is speaking.

These and additional objects, advantages, features and benefits of the present invention will become apparent from the following specification.

### BRIEF DESCRIPTION OF THE DRAWINGS

FIG. 1 is a block diagram of a speech recognition module interacting with a speech recognition engine in accordance with the present invention.

FIG. 2a is a first page of a character mapping chart disclosing the location of each character in a mapping text file and a module mapping text file of a speech recognition module in accordance with the present invention.

FIG. 2b is a second page of a character mapping chart of a speech recognition module in accordance with the present invention.

FIG. 2c is a third page of a character mapping chart of a speech recognition module in accordance with the present invention.

FIG. 2d is a fourth page of a character mapping chart of a speech recognition module in accordance with the present invention.

FIG. 2e is a fifth page of a character mapping chart of a speech recognition module in accordance with the present invention.

FIG. 3 is a front view of an editing window of a speech recognition engine.

FIG. 4 is a front view of a module window of a speech recognition module in accordance with the present invention.

### DETAILED DESCRIPTION OF THE PREFERRED EMBODIMENTS

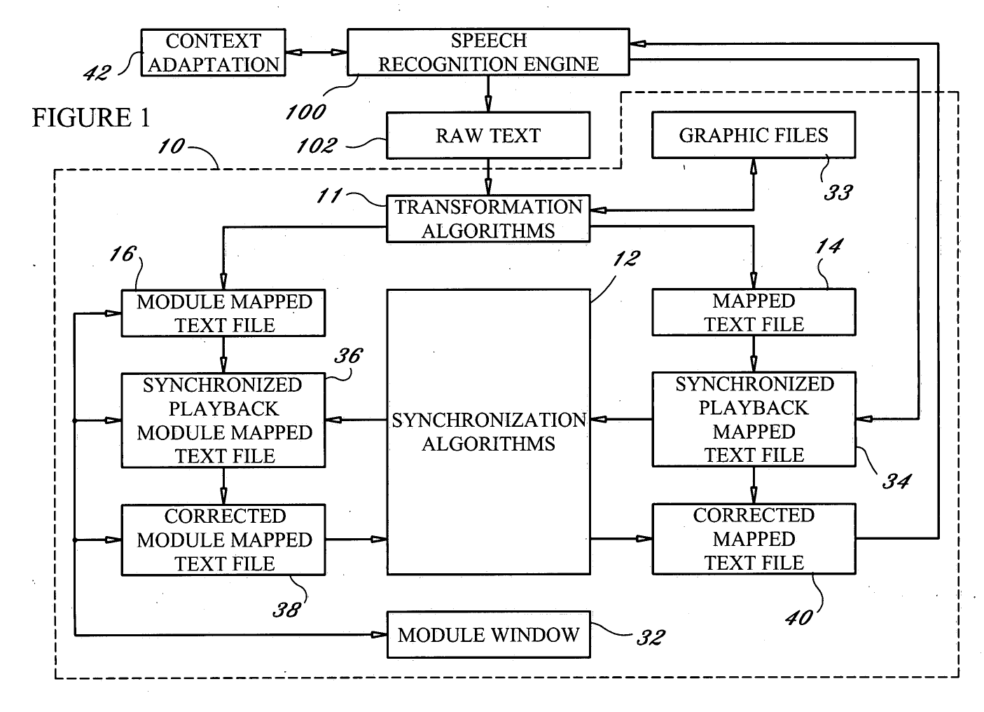

With reference now to the drawings, and particularly to FIG. 1, there is shown a block diagram of a speech recognition module 10 interacting with a speech recognition engine 100. The speech recognition module 10 includes transformation algorithms 11 and synchronization algorithms 12. The transformation algorithms 11 receive raw text 102 from the speech recognition engine 100 and produce a mapped text file 14 and a module mapped text file 16. The mapped text file 14 contains all the characters in the raw text file. Any command text strings in the mapped text file 14 are replaced with alphabetic or numeric characters in the module mapped text file 16.

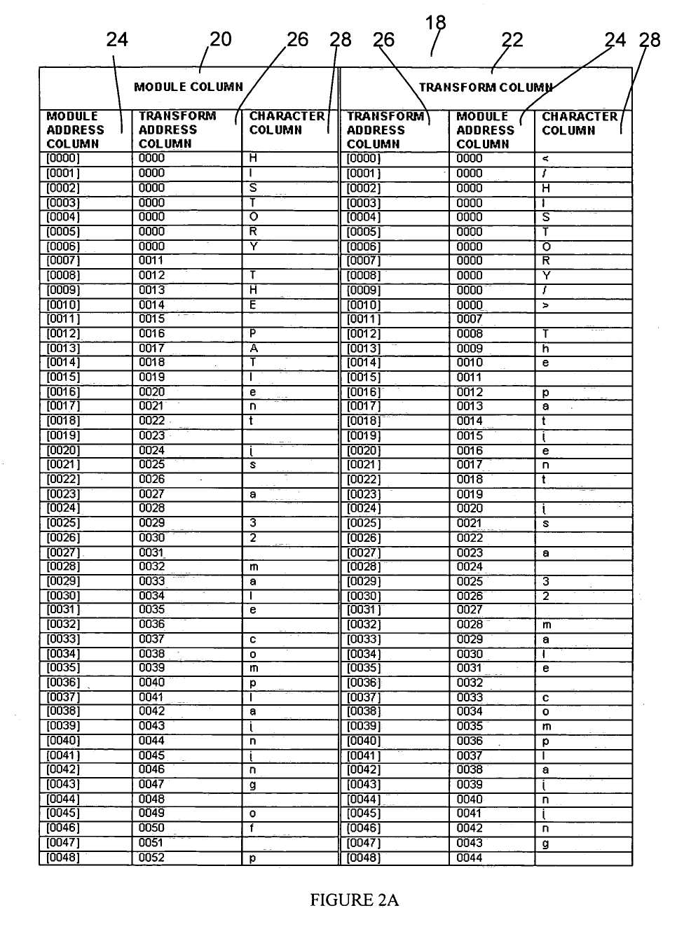

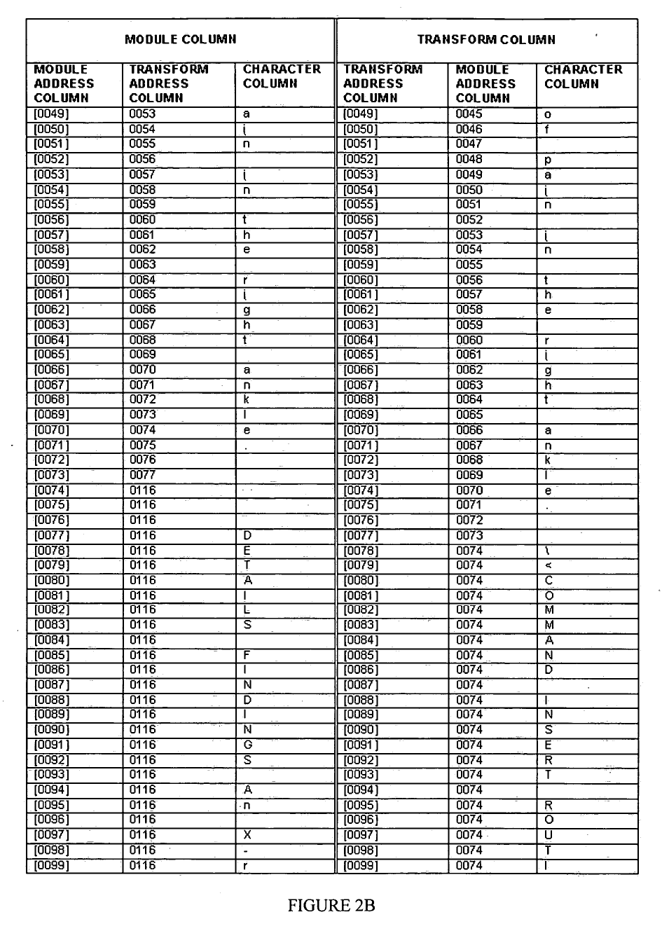

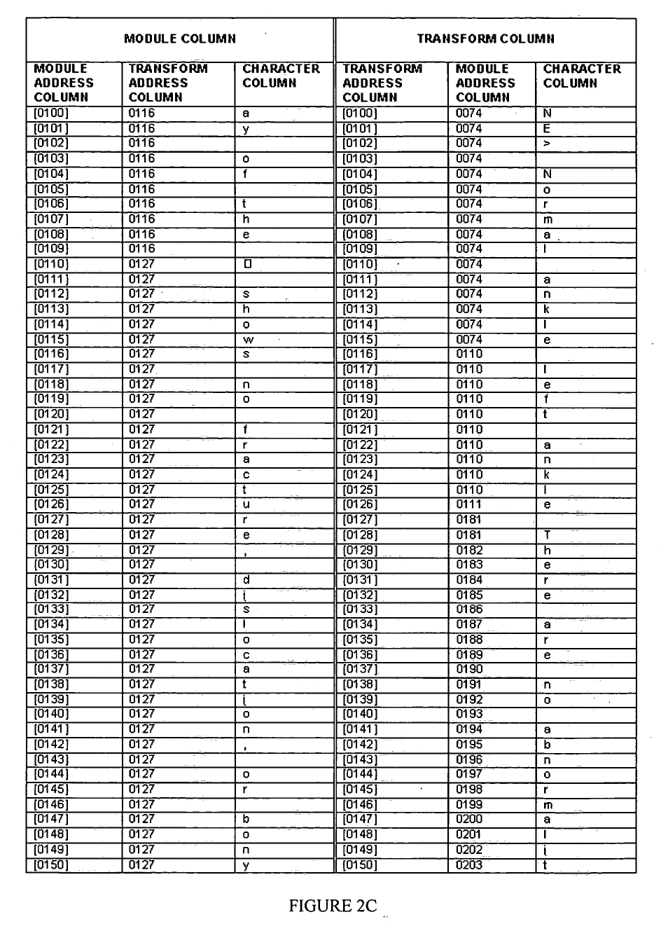

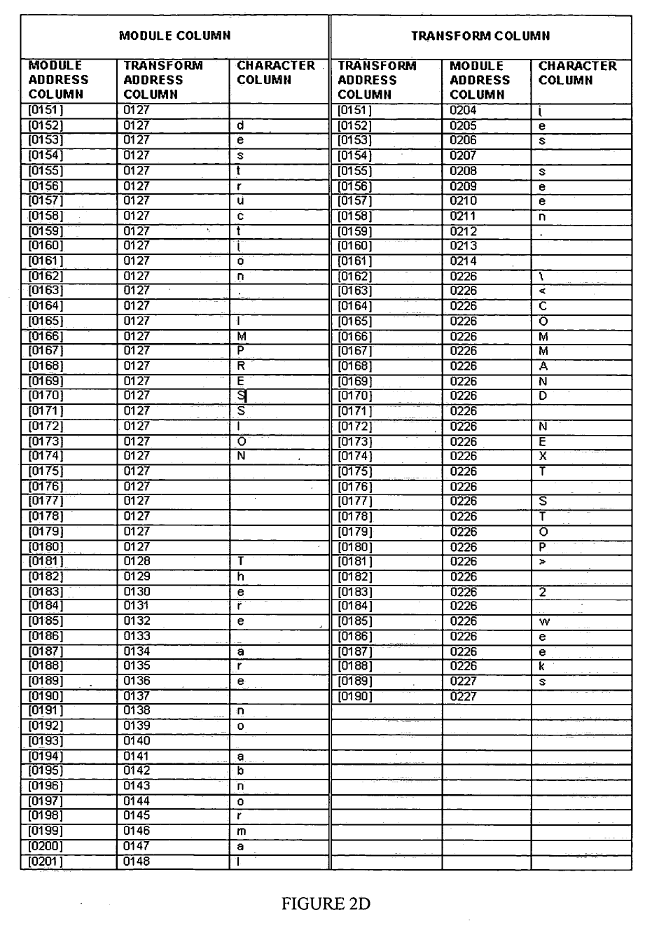

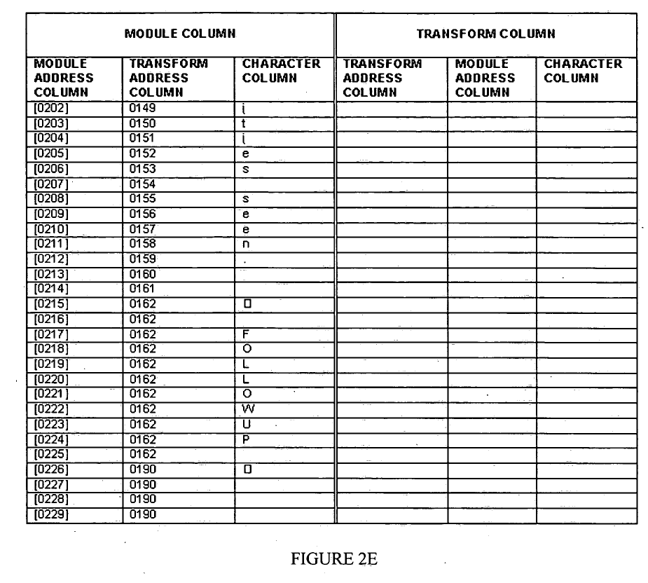

With reference to FIGS. 2a-2e, all the characters in the mapped text file 14 and all the characters in the module mapped text file 16 are recorded in a character mapping chart 18. The character mapping chart 18 includes a module column 20 storing the contents of the module mapped text file 16 and a transform column 22 storing the contents of the mapped text file 14. The module column 20 includes a module address column 24, a transform address column 26 and a character column 28. The transform column 22 includes the transform address column 26, the module address column 24 and the character column 28. Viewing a module address in the module address column 24 provides a transform address in the transform address column 26, which maps to an address in the transform address column 26 of the transform column 22.

The following is an example of mapping contained in the character mapping chart 18. An address of the first letter of the word “patient” in the module address column 24 of the module column 20 is “0012.” The corresponding transform address column 26 provides an address of “0016.” Locating the address “0016” in the transform address column 26 of the transform column 22 provides a letter “p” in the character column 28 of the transform column 22. With reference to FIG. 4, prewritten embedded text in a table will appear in the module mapped text file 16 and will be mapped to an address in the mapped text file 14, but the prewritten embedded text will not appear in the mapped text file 14. An example of the prewritten embedded text is “An X-ray of the (first drop down menu 37) shows no fracture, dislocation, or bony destruction.” Commands appearing in the mapping text file 14 will be mapped to an address in the module mapping text file 16, but the commands will not appear in the module mapping file 16.

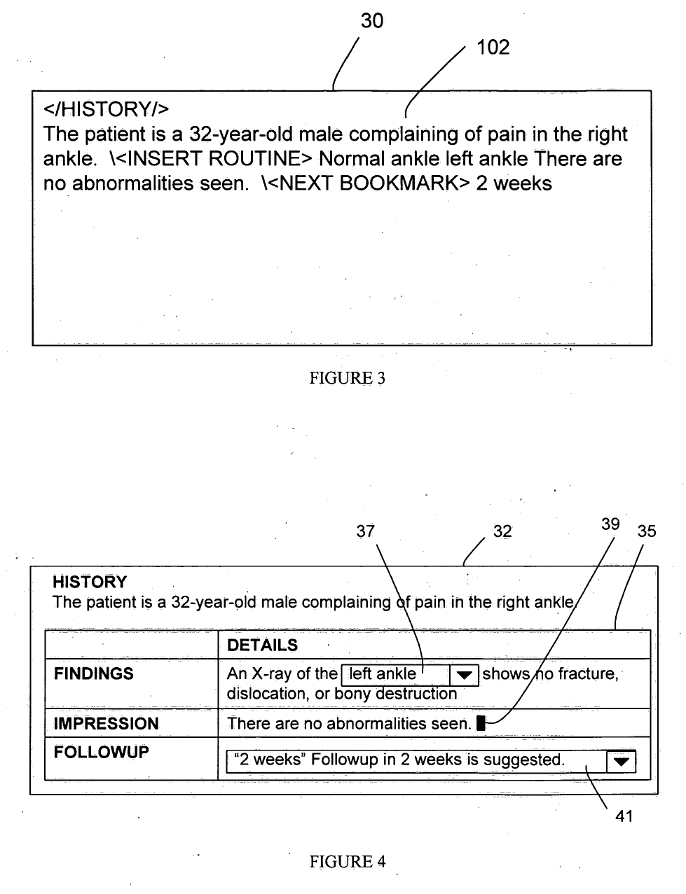

With reference to FIG. 3, the speech recognition engine 100 normally provides an editing window 30 for making corrections to the raw text. However, when using the speech recognition module 10, the editing window is preferably hidden. The following is an example of a dictation that corresponds to that shown in the editing window 30 in FIG. 3: “HISTORY The patient is a 32-year-old male complaining of pain in the right ankle INSERT ROUTINE normal ankle left ankle There are no abnormalities seen NEXT BOOKMARK 2 weeks.”

With reference to FIG. 4, a module window 32 is created by the speech recognition module 10 to view the module mapped text file 16. Any graphical display, such as tables, fill-in forms, insertion of normal text or headers are viewable during or after dictation in the module window 32. Normal text based on dictation may be seen as it is spoken in the fill-in form. A particular graphic display, such as a fill-in form is displayed in the module window 32, when transformation algorithms 11 call for that particular graphic file in block 33. For purposes of this patent application, a graphic file is defined as a fill-in form, a table, a drop down menu, a header, prewritten text and any item other than dictated text. An insert command in the raw text 102 directs the transformation algorithms 11 to search for the appropriate graphic file.

The contents of the module window 32 correspond to the example dictation. The word HISTORY is a header that is shown in bold in the module window 32. The sentence of “The patient is a 32 year-old male complaining of pain in the right ankle” is dictated after the HISTORY header and appears as normal text and appears under the HISTORY header. The command “INSERT ROUTINE” and the phrase “normal ankle” cause an entire table 35 to be inserted in the module window 32. The phrase “left ankle” causes left ankle to be chosen from a first drop down menu 37 in the table 35 and causes a cursor 39 to move to the next point of insertion. Next, the phrase, “There are no abnormalities seen” is dictated and inserted in the table 35 as normal text. The command “NEXT BOOKMARK” causes the cursor 39 to move to the next insertion point. The phrase “two weeks” causes a “2 weeks” option to be selected from a second drop down menu 41.

The speech recognition engine 100 provides synchronized playback capabilities for the mapped text file 14 in block 34. When the recorded dictation is played back, the current spoken word is highlighted in the mapped text file 14. The synchronization algorithms 12 read the values stored in the transform column 22 of the character mapping chart 18 in order to highlight the proper characters in the module mapped text file 14 in block 36. The module mapped text file 14 in block 36 is viewed in the module window 32. Corrections are made to the module mapped text file 16 in block 38 and then automatically implemented in the mapped text file 14 in block 40. Mappings contained in FIGS. 2a-2e in the module column 20 and the transform column 22 are updated by the synchronization algorithms 12. The final corrected mapped text file 40 is sent to the speech recognition engine 100 for context adaptation in block 42 by instruction from the user to the speech recognition module 10.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

1. A method of providing real time graphic display capability for a speech recognition engine, comprising the steps of:
providing said speech recognition engine, said speech recognition engine providing raw text in response to speech dictation;
transforming said raw text into a mapped text file and into a module mapped text file;
providing a module window for displaying said module mapped text file in real time;
editing said module mapped text file in said module window; and
synchronizing changes made in said module mapped text file to said mapped text file.

2. The method of providing real time graphic display capability for a speech recognition engine of claim 1, further comprising the step of:
processing said mapped text file with context adaptation.

3. The method of providing real time graphic display capability for a speech recognition engine of claim 1, further comprising the step of:
accessing a graphic file to provide a graphic representation of a command in said raw text.

4. The method of providing real time graphic display capability for a speech recognition engine of claim 1, further comprising the step of:
creating a character mapping chart having a module column and a transform column, storing said module mapping text file in said module column and storing said mapping text file in said transform column.

5. The method of providing real time graphic display capability for a speech recognition engine of claim 4, further comprising the steps of:
assigning a module address for each module character in said module mapping text file, including a transform address that is mapped to a transform address in said transform column; and
assigning a transform address for each transform character in said mapping text file, including a module address that is mapped to a module address in said module column.

6. The method of providing real time graphic display capability for a speech recognition engine of claim 1, further comprising the step of:
mapping characters highlighted in said mapped text file with synchronized playback to said module mapped text file.

7. The method of providing real time graphic display capability for a speech recognition engine of claim 1, further comprising the step of:
hiding an editing window of said speech recognition engine.

8. A method of providing real time graphic display capability for a speech recognition engine, comprising the steps of:
providing said speech recognition engine, said speech recognition engine providing raw text in response to speech dictation;
transforming said raw text into a mapped text file and into a module mapped text file;
providing a module window for displaying said module mapped text file in real time;
editing said mapped text file in said module window;
synchronizing changes made in said module mapped text file to said mapped text file; and
processing said mapped text file with context adaptation.

9. The method of providing real time graphic display capability for a speech recognition engine of claim 8, further comprising the step of:
accessing a graphic file to provide a graphic representation of a command in said raw text.

10. The method of providing real time graphic display capability for a speech recognition engine of claim 8, further comprising the step of:
creating a character mapping chart having a module column and a transform column, storing said module mapping text file in said module column and storing said mapping text file in said transform column.

11. The method of providing real time graphic display capability for a speech recognition engine of claim 10, further comprising the steps of:
assigning a module address for each module character in said module mapping text file, including a transform address that is mapped to a transform address in said transform column; and
assigning a transform address for each transform character in said mapping text file, including a module address that is mapped to a module address in said module column.

12. The method of providing real time graphic display capability for a speech recognition engine of claim 8, further comprising the step of:
mapping characters highlighted in said mapped text file with synchronized playback to said module mapped text file.

13. The method of providing real time graphic display capability for a speech recognition engine of claim 8, further comprising the step of:
hiding an editing window of said speech recognition engine.

14. A method of providing real time graphic display capability for a speech recognition engine, comprising the steps of:
providing said speech recognition engine, said speech recognition engine providing raw text in response to speech dictation;
transforming said raw text into a mapped text file and into a module mapped text file;
providing a module window for displaying said module mapped text file in real time;
editing said mapped text file in said module window;
synchronizing changes made in said module mapped text file to said mapped text file;
processing said mapped text file with context adaptation; and
accessing a graphic file to provide a graphic representation of a command in said raw text.

15. The method of providing real time graphic display capability for a speech recognition engine of claim 14, further comprising the step of:
creating a character mapping chart having a module column and a transform column, storing said module mapping text file in said module column and storing said mapping text file in said transform column.

16. The method of providing real time graphic display capability for a speech recognition engine of claim 15, further comprising the steps of:
assigning a module address for each module character in said module mapping text file, including a transform address that is mapped to a transform address in said mapped text file; and
assigning a transform address for each transform character in said mapping text file, including a module address that is mapped to a module address in said module mapped text file.

17. The method of providing real time graphic display capability for a speech recognition engine of claim 14, further comprising the step of:
mapping characters highlighted in said mapped text file with synchronized playback to said module mapped text file.

18. The method of providing real time graphic display capability for a speech recognition engine of claim 14, further comprising the step of:
hiding an editing window of said speech recognition engine.
